(19) United States
(12) Patent Application Publication
(10) Pub. No.: US 2023/0410737 A1
(43) Pub. Date: Dec. 21, 2023

(54) DISPLAY DEVICE AND OPERATING METHOD THEREOF

(71) Applicant: LG ELECTRONICS INC., Seoul (KR)

(72) Inventor: Youngho CHUN, Seoul (KR)

(73) Assignee: LG ELECTRONICS INC., Seoul (KR)

(21) Appl. No.: 17/815,124

(22) Filed: Jul. 26, 2022

(30) Foreign Application Priority Data
Jun. 16, 2022 (KR) 10-2022-0073370

(51) Int. Cl. G09G 3/3233

(52) U.S. Cl. CPC G09G 3/3233; G09G 2320/0257; G09G 2320/0626; G09G 2320/0686; G09G 2300/0842

(57) ABSTRACT

A display device comprises a display unit configured to display a still image, and a controller configured to turn on a luminance control function for lowering luminance of the still image to default peak luminance when there is no change in the still image for a predetermined time period and to turn off the luminance control function when a preset pattern is detected in a state in which the luminance control function is turned on.

### CROSS-REFERENCE TO RELATED APPLICATION(S)

Pursuant to 35 U.S.C. § 119(a), this application claims the benefit of earlier filing date and right of priority to Korean Patent Application No. 10-2022-0073370, filed on Jun. 16, 2022, the contents of which are hereby incorporated by reference herein in its entirety.

### BACKGROUND OF THE INVENTION

### 1. Field of the Invention

The present disclosure relates to a display device, and more particularly, to an organic light emitting diode display device.

### 2. Discussion of the Related Art

Recently, types of display devices have been diversified. Among them, an organic light emitting diode display device (hereinafter referred to as an “OLED display device”) is widely used.

An OLED display device is a display device using an organic light emitting element. Since the organic light emitting device is a self-light-emitting device, the OLED display device has advantages of having lower power consumption and manufactured to be thinner than a liquid crystal display device requiring a backlight. In addition, the OLED display device has a wide viewing angle and a fast response speed.

A temporal peak luminance control (hereinafter referred to as TPC) function is a function for preventing occurrence of an afterimage, by significantly lowering the luminance of a screen when a still image is displayed for a long time, in order to reduce the risk of afterimage occurrence.

In the OLED display device, the function of time peak luminance control is basically applied.

However, in the conventional TPC function, as the luminance is significantly lowered, when viewing an image that does not change frequently, the screen becomes dark and the original luminance is not easily restored, causing user viewing inconvenience.

### SUMMARY OF THE INVENTION

An object of the present disclosure is to prevent a luminance control function for lowering luminance from being performed, by detecting a state in which a user is working.

An object of the present disclosure is to solve a problem in which a TPC function is maintained during mouse movement or document work.

A display device according to an embodiment of the present disclosure may comprise a display unit configured to display a still image, and a controller configured to turn on a luminance control function for lowering luminance of the still image to default peak luminance when there is no change in the still image for a predetermined time period and to turn off the luminance control function when a preset pattern is detected in a state in which the luminance control function is turned on.

A method of operating a display device according to another embodiment of the present disclosure may comprise displaying a still image on a display unit, turning on a luminance control function for lowering luminance of the still image to default peak luminance when there is no change in the still image for a predetermined time period, and turning off the luminance control function when a preset pattern is detected in a state in which the luminance control function is turned on.

According to an embodiment of the present disclosure, the display device may turn off the TPC function as the mouse movement pattern is detected, thereby preventing interference with the user's PC work.

Accordingly, it is possible to prevent interference with a user's work environment due to unnecessary darkening of the luminance of a screen.

### BRIEF DESCRIPTION OF THE DRAWINGS

FIG. 1 is a diagram illustrating a display device according to an embodiment of the present disclosure.

FIG. 2 is a block diagram illustrating a configuration of the display device of FIG. 1.

FIG. 3 is an example of an internal block diagram of a control unit of FIG. 2.

FIG. 4A is a diagram illustrating a control method for a remote control device of FIG. 2.

FIG. 4B is an internal block diagram of the remote control device of FIG. 2.

FIG. 5 is an internal block diagram of a display unit of FIG. 2.

FIGS. 6A to 6B are views referred to for description of an organic light emitting panel of FIG. 5.

FIG. 7 is a flowchart illustrating a method of operating a display device according to an embodiment of the present disclosure.

FIGS. 8A to 10 are views illustrating a process of detecting a document work pattern according to an embodiment of the present disclosure.

FIGS. 11 to 14 are views illustrating a process of detecting a mouse movement pattern according to an embodiment of the present disclosure.

FIG. 15 is a view illustrating a process of executing a screen saver function when default peak luminance is maintained for a preset time after the TPC function is turned on according to an embodiment of the present disclosure.

FIG. 16 is a view illustrating a process of setting a screen saver function of a PC connected to a display device according to an embodiment of the present disclosure.

FIGS. 17A to 17D are diagrams illustrating an exceptional situation in which the TPC function is not turned off even when a block change occurs while the TPC function is turned on according to an embodiment of the present disclosure.

FIG. 18 is a diagram illustrating a configuration of a stand-type display device according to an embodiment of the present disclosure.

FIGS. 19A to 19C are diagrams illustrating a configuration of a flexible display device according to an embodiment of the present disclosure.

### DETAILED DESCRIPTION OF THE PREFERRED EMBODIMENTS

Hereinafter, the present disclosure will be described in more detail with reference to the drawings.

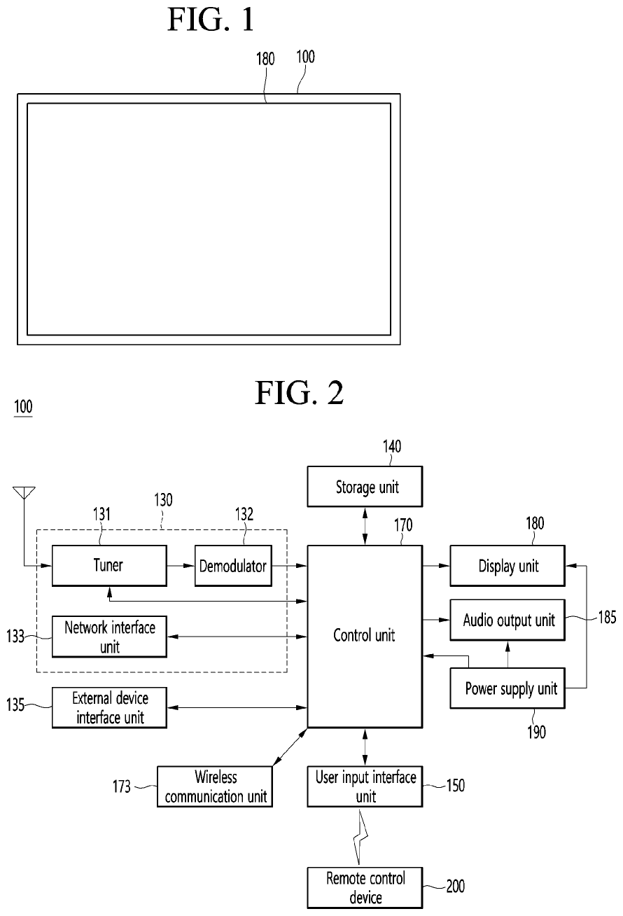

FIG. 1 is a diagram illustrating a display device according to an embodiment of the present disclosure.

Referring to the drawings, a display device 100 may include a display unit 180.

Meanwhile, the display unit 180 may be implemented with any one of various panels. For example, the display unit 180 may be any one of a liquid crystal display panel (LCD panel), an organic light emitting diode panel (OLED panel), and an inorganic light emitting diode panel (LED panel).

In the present disclosure, it is assumed that the display unit 180 includes an organic light emitting diode panel (OLED panel). It should be noted that this is only exemplary, and the display unit 180 may include a panel other than an organic light emitting diode panel (OLED panel).

Meanwhile, the display device 100 of FIG. 1 may be a monitor, a TV, a tablet PC, or a mobile terminal.

FIG. 2 is a block diagram showing a configuration of the display device of FIG. 1.

Referring to FIG. 2, the display device 100 may include a broadcast receiving unit 130, an external device interface unit 135, a storage unit 140, a user input interface unit 150, a control unit 170, and a wireless communication unit 173, a display unit 180, an audio output unit 185, and a power supply unit 190.

The broadcast receiving unit 130 may include a tuner 131, a demodulator 132, and a network interface unit 133.

The tuner 131 may select a specific broadcast channel according to a channel selection command. The tuner 131 may receive a broadcast signal for the selected specific broadcast channel.

The demodulator 132 may separate the received broadcast signal into a video signal, an audio signal, and a data signal related to a broadcast program, and restore the separated video signal, audio signal, and data signal to a format capable of being output.

The network interface unit 133 may provide an interface for connecting the display device 100 to a wired/wireless network including an Internet network. The network interface unit 133 may transmit or receive data to or from other users or other electronic devices through a connected network or another network linked to the connected network.

The network interface unit 133 may access a predetermined web page through the connected network or the other network linked to the connected network. That is, it is possible to access a predetermined web page through a network, and transmit or receive data to or from a corresponding server.

In addition, the network interface unit 133 may receive content or data provided by a content provider or a network operator. That is, the network interface unit 133 may receive content such as a movie, advertisement, game, VOD, broadcast signal, and related information provided by a content provider or a network provider through a network.

In addition, the network interface unit 133 may receive update information and update files of firmware provided by the network operator, and may transmit data to an Internet or content provider or a network operator.

The network interface unit 133 may select and receive a desired application from among applications that are open to the public through a network.

The external device interface unit 135 may receive an application or a list of applications in an external device adjacent thereto, and transmit the same to the control unit 170 or the storage unit 140.

The external device interface unit 135 may provide a connection path between the display device 100 and the external device. The external device interface unit 135 may receive one or more of video and audio output from an external device wirelessly or wired to the display device 100 and transmit the same to the control unit 170. The external device interface unit 135 may include a plurality of external input terminals. The plurality of external input terminals may include an RGB terminal, one or more High Definition Multimedia Interface (HDMI) terminals, and a component terminal.

The video signal of the external device input through the external device interface unit 135 may be output through the display unit 180. The audio signal of the external device input through the external device interface unit 135 may be output through the audio output unit 185.

The external device connectable to the external device interface unit 135 may be any one of a set-top box, a Blu-ray player, a DVD player, a game machine, a sound bar, a smartphone, a PC, a USB memory, and a home theater, but this is only an example.

In addition, a part of content data stored in the display device 100 may be transmitted to a selected user among a selected user or a selected electronic device among other users or other electronic devices registered in advance in the display device 100.

The storage unit 140 may store programs for signal processing and control of the control unit 170, and may store video, audio, or data signals, which have been subjected to signal-processed.

In addition, the storage unit 140 may perform a function for temporarily storing video, audio, or data signals input from an external device interface unit 135 or the network interface unit 133, and store information on a predetermined video through a channel storage function.

The storage unit 140 may store an application or a list of applications input from the external device interface unit 135 or the network interface unit 133.

The display device 100 may play back a content file (a moving image file, a still image file, a music file, a document file, an application file, or the like) stored in the storage unit 140 and provide the same to the user.

The user input interface unit 150 may transmit a signal input by the user to the control unit 170 or a signal from the control unit 170 to the user. For example, the user input interface unit 150 may receive and process a control signal such as power on/off, channel selection, screen settings, and the like from the remote control device 200 in accordance with various communication methods, such as a Bluetooth communication method, a WB (Ultra Wideband) communication method, a ZigBee communication method, an RF (Radio Frequency) communication method, or an infrared (IR) communication method or may perform processing to transmit the control signal from the control unit 170 to the remote control device 200.

In addition, the user input interface unit 150 may transmit a control signal input from a local key (not shown) such as a power key, a channel key, a volume key, and a setting value to the control unit 170.

The video signal image-processed by the control unit 170 may be input to the display unit 180 and displayed with video corresponding to a corresponding video signal. Also, the video signal image-processed by the control unit 170 may be input to an external output device through the external device interface unit 135.

The audio signal processed by the control unit 170 may be output to the audio output unit 185. Also, the audio signal processed by the control unit 170 may be input to the external output device through the external device interface unit 135.

In addition, the control unit 170 may control the overall operation of the display device 100.

In addition, the control unit 170 may control the display device 100 by a user command input through the user input interface unit 150 or an internal program and connect to a network to download an application a list of applications or applications desired by the user to the display device 100.

The control unit 170 may allow the channel information or the like selected by the user to be output through the display unit 180 or the audio output unit 185 along with the processed video or audio signal.

In addition, the control unit 170 may output a video signal or an audio signal through the display unit 180 or the audio output unit 185, according to a command for playing back a video of an external device through the user input interface unit 150, the video signal or the audio signal being input from an external device, for example, a camera or a camcorder, through the external device interface unit 135.

Meanwhile, the control unit 170 may allow the display unit 180 to display a video, for example, allow a broadcast video which is input through the tuner 131 or an external input video which is input through the external device interface unit 135, a video which is input through the network interface unit or a video which is stored in the storage unit 140 to be displayed on the display unit 180. In this case, the video displayed on the display unit 180 may be a still image or a moving image, and may be a 2D image or a 3D image.

In addition, the control unit 170 may allow content stored in the display device 100, received broadcast content, or external input content input from the outside to be played back, and the content may have various forms such as a broadcast video, an external input video, an audio file, still images, accessed web screens, and document files.

The wireless communication unit 173 may communicate with an external device through wired or wireless communication. The wireless communication unit 173 may perform short range communication with an external device. To this end, the wireless communication unit 173 may support short range communication using at least one of Bluetooth™, Bluetooth Low Energy (BLE), Radio Frequency Identification (RFID), Infrared Data Association (IrDA), Ultra Wideband (UWB), ZigBee, Near Field Communication (NFC), Wi-Fi (Wireless-Fidelity), Wi-Fi (Wireless-Fidelity), Wi-Fi Direct, and Wireless USB (Wireless Universal Serial Bus) technologies. The wireless communication unit 173 may support wireless communication between the display device 100 and a wireless communication system, between the display device 100 and another display device 100, or between the display device 100 and a network in which the display device 100 (or an external server) is located through wireless area networks. The wireless area networks may be wireless personal area networks.

Here, the another display device 100 may be a wearable device (e.g., a smartwatch, smart glasses or a head mounted display (HMD), a mobile terminal such as a smart phone, which is able to exchange data (or interwork) with the display device 100 according to the present disclosure. The wireless communication unit 173 may detect (or recognize) a wearable device capable of communication around the display device 100. Furthermore, when the detected wearable device is an authenticated device to communicate with the display device 100 according to the present disclosure, the control unit 170 may transmit at least a portion of data processed by the display device 100 to the wearable device through the wireless communication unit 173. Therefore, a user of the wearable device may use data processed by the display device 100 through the wearable device.

The display unit 180 may convert a video signals, data signal, or OSD signal processed by the control unit 170, or a video signal or data signal received from the external device interface unit 135 into R, G, and B signals, and generate drive signals.

Meanwhile, the display device 100 illustrated in FIG. 2 is only an embodiment of the present disclosure, and therefore, some of the illustrated components may be integrated, added, or omitted depending on the specification of the display device 100 that is actually implemented.

That is, two or more components may be combined into one component, or one component may be divided into two or more components as necessary. In addition, a function performed in each block is for describing an embodiment of the present disclosure, and its specific operation or device does not limit the scope of the present disclosure.

According to another embodiment of the present disclosure, unlike the display device 100 shown in FIG. 2, the display device 100 may receive a video through the network interface unit 133 or the external device interface unit 135 without a tuner 131 and a demodulator 132 and play back the same.

For example, the display device 100 may be divided into an image processing device, such as a set-top box, for receiving broadcast signals or content according to various network services, and a content playback device that plays back content input from the image processing device.

In this case, an operation method of the display device according to an embodiment of the present disclosure will be described below may be implemented by not only the display device 100 as described with reference to FIG. 2 and but also one of an image processing device such as the separated set-top box and a content playback device including the display unit 180 the audio output unit 185.

The audio output unit 185 may receive a signal audio-processed by the control unit 170 and output the same with audio.

The power supply unit 190 may supply corresponding power to the display device 100. Particularly, power may be supplied to the control unit 170 that may be implemented in the form of a system on chip (SOC), the display unit 180 for video display, and the audio output unit 185 for audio output.

Specifically, the power supply unit 190 may include a converter that converts AC power into DC power, and a dc/dc converter that converts a level of DC power.

The remote control device 200 may transmit a user input to the user input interface unit 150. To this end, the remote control device 200 may use Bluetooth, Radio Frequency (RF) communication, Infrared (IR) communication, Ultra Wideband (UWB), ZigBee, or the like. In addition, the remote control device 200 may receive a video, audio, or data signal or the like output from the user input interface unit 150, and display or output the same through the remote control device 200 by video or audio.

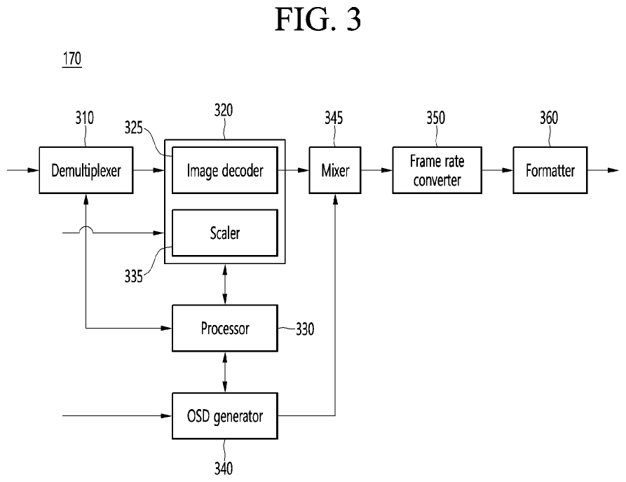

FIG. 3 is an example of an internal block diagram of the controller of FIG. 2.

Referring to the drawings, the control unit 170 according to an embodiment of the present disclosure may include a demultiplexer 310, an image processing unit 320, a processor 330, an OSD generator 340, a mixer 345, a frame rate converter 350, and a formatter 360. In addition, an audio processing unit (not shown) and a data processing unit (not shown) may be further included.

The demultiplexer 310 may demultiplex input stream. For example, when MPEG-2 TS is input, the demultiplexer 310 may demultiplex the MPEG-2 TS to separate the MPEG-2 TS into video, audio, and data signals. Here, the stream signal input to the demultiplexer 310 may be a stream signal output from the tuner 131, the demodulator 132 or the external device interface unit 135.

The image processing unit 320 may perform image processing on the demultiplexed video signal. To this end, the image processing unit 320 may include an image decoder 325 and a scaler 335.

The image decoder 325 may decode the demultiplexed video signal, and the scaler 335 may scale a resolution of the decoded video signal to be output through the display unit 180.

The video decoder 325 may be provided with decoders of various standards. For example, an MPEG-2, H.264 decoder, a 3D video decoder for color images and depth images, and a decoder for multi-view images may be provided.

The processor 330 may control the overall operation of the display device 100 or of the control unit 170. For example, the processor 330 may control the tuner 131 to select (tune) an RF broadcast corresponding to a channel selected by a user or a pre-stored channel.

In addition, the processor 330 may control the display device 100 by a user command input through the user input interface unit 150 or an internal program.

In addition, the processor 330 may perform data transmission control with the network interface unit 135 or the external device interface unit 135.

In addition, the processor 330 may control operations of the demultiplexer 310, the image processing unit 320, and the OSD generator 340 in the control unit 170.

The OSD generator 340 may generate an OSD signal according to a user input or by itself. For example, based on a user input signal, a signal for displaying various information on a screen of the display unit 180 as a graphic or text may be generated. The generated OSD signal may include various data such as a user interface screen, various menu screens, widgets, and icons of the display device 100. In addition, the generated OSD signal may include a 2D object or a 3D object.

In addition, the OSD generator 340 may generate a pointer that may be displayed on the display unit 180 based on a pointing signal input from the remote control device 200. In particular, such a pointer may be generated by the pointing signal processing unit, and the OSD generator 340 may include such a pointing signal processing unit (not shown). Of course, the pointing signal processing unit (not shown) may be provided separately, not be provided in the OSD generator 340

The mixer 345 may mix the OSD signal generated by the OSD generator 340 and the decoded video signal image-processed by the image processing unit 320. The mixed video signal may be provided to the frame rate converter 350.

The frame rate converter (FRC) 350 may convert a frame rate of an input video. On the other hand, the frame rate converter 350 may output the input video as it is, without a separate frame rate conversion.

On the other hand, the formatter 360 may change the format of the input video signal into a video signal to be displayed on the display and output the same.

The formatter 360 may change the format of the video signal. For example, it is possible to change the format of the 3D video signal to any one of various 3D formats such as a side by side format, a top/down format, a frame sequential format, an interlaced format, a checker box and the like.

Meanwhile, the audio processing unit (not shown) in the control unit 170 may perform audio processing of a demultiplexed audio signal. To this end, the audio processing unit (not shown) may include various decoders.

In addition, the audio processing unit (not shown) in the control unit 170 may process a base, treble, volume control, and the like.

The data processing unit (not shown) in the control unit 170 may perform data processing of the demultiplexed data signal. For example, when the demultiplexed data signal is an encoded data signal, the demultiplexed data signal may be decoded. The coded data signal may be electronic program guide information including broadcast information such as a start time and an end time of a broadcast program broadcast on each channel.

Meanwhile, a block diagram of the control unit 170 illustrated in FIG. 3 is a block diagram for an embodiment of the present disclosure. The components of the block diagram may be integrated, added, or omitted depending on the specification of the control unit 170 that is actually implemented.

In particular, the frame rate converter 350 and the formatter 360 may not be provided in the control unit 170, and may be separately provided or separately provided as a single module.

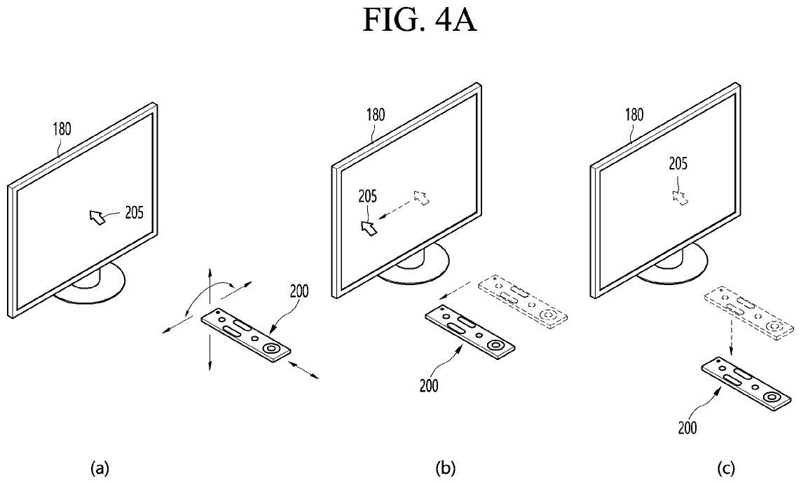

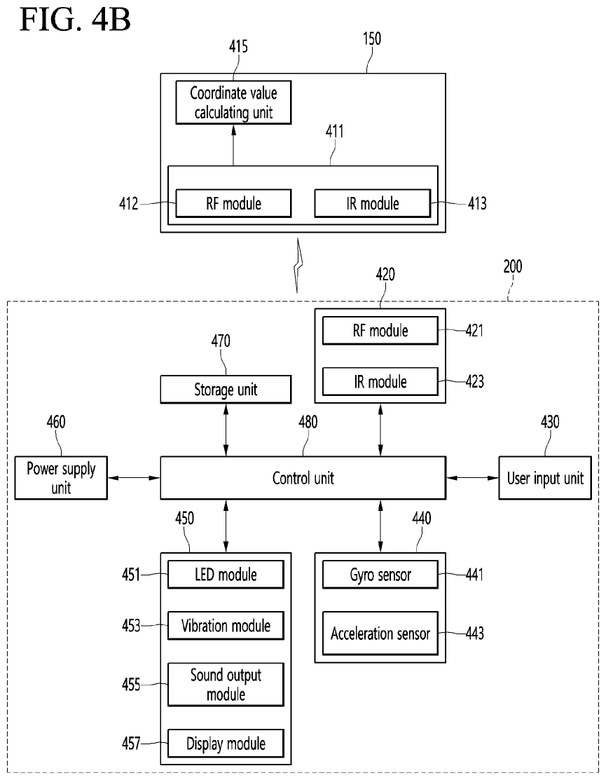

FIG. 4A is a diagram illustrating a control method for a remote control device of FIG. 2.

In (a) of FIG. 4A, it is illustrated that a pointer 205 corresponding to the remote control device 200 is displayed on the display unit 180.

The user may move or rotate the remote control device 200 up and down, left and right (FIG. 4A (b)), and forward and backward ((c) of FIG. 4A). The pointer 205 displayed on the display unit 180 of the display device may correspond to the movement of the remote control device 200. The remote control device 200 may be referred to as a spatial remote controller or a 3D pointing device, as the corresponding pointer 205 is moved and displayed according to the movement on a 3D space, as shown in the drawing.

In (b) of FIG. 4A, it is illustrated that that when the user moves the remote control device 200 to the left, the pointer 205 displayed on the display unit 180 of the display device moves to the left correspondingly.

Information on the movement of the remote control device 200 detected through a sensor of the remote control device 200 is transmitted to the display device. The display device may calculate the coordinates of the pointer 205 based on information on the movement of the remote control device 200. The display device may display the pointer 205 to correspond to the calculated coordinates.

In (c) of FIG. 4A, it is illustrated that a user moves the remote control device 200 away from the display unit 180 while pressing a specific button in the remote control device 200. Accordingly, a selected region in the display unit 180 corresponding to the pointer 205 may be zoomed in and displayed to be enlarged. Conversely, when the user moves the remote control device 200 close to the display unit 180, the selected region in the display unit 180 corresponding to the pointer 205 may be zoomed out and displayed to be reduced. On the other hand, when the remote control device 200 moves away from the display unit 180, the selected region may be zoomed out, and when the remote control device 200 moves close to the display unit 180, the selected region may be zoomed in.

Meanwhile, in a state in which a specific button in the remote control device 200 is being pressed, recognition of up, down, left, or right movements may be excluded. That is, when the remote control device 200 moves away from or close to the display unit 180, the up, down, left, or right movements are not recognized, and only the forward and backward movements may be recognized. In a state in which a specific button in the remote control device 200 is not being pressed, only the pointer 205 moves according to the up, down, left, or right movements of the remote control device 200.

Meanwhile, the movement speed or the movement direction of the pointer 205 may correspond to the movement speed or the movement direction of the remote control device 200.

FIG. 4B is an internal block diagram of the remote control device of FIG. 2.

Referring to the drawing, the remote control device 200 may include a wireless communication unit 420, a user input unit 430, a sensor unit 440, an output unit 450, a power supply unit 460, a storage unit 470, ad a control unit 480.

The wireless communication unit 420 may transmit and receive signals to and from any one of the display devices according to the embodiments of the present disclosure described above. Among the display devices according to embodiments of the present disclosure, one display device 100 will be described as an example.

In the present embodiment, the remote control device 200 may include an RF module 421 capable of transmitting and receiving signals to and from the display device 100 according to the RF communication standard. In addition, the remote control device 200 may include an IR module 423 capable of transmitting and receiving signals to and from the display device 100 according to the IR communication standard.

In the present embodiment, the remote control device 200 transmits a signal containing information on the movement of the remote control device 200 to the display device 100 through the RF module 421.

Also, the remote control device 200 may receive a signal transmitted by the display device 100 through the RF module 421. In addition, the remote control device 200 may transmit a command regarding power on/off, channel change, volume adjustment, or the like to the display device 100 through the IR module 423 as necessary.

The user input unit 430 may include a keypad, a button, a touch pad, or a touch screen. The user may input a command related to the display device 100 to the remote control device 200 by operating the user input unit 430. When the user input unit 430 includes a hard key button, the user may input a command related to the display device 100 to the remote control device 200 through a push operation of the hard key button. When the user input unit 430 includes a touch screen, the user may input a command related to the display device 100 to the remote control device 200 by touching a soft key of the touch screen. In addition, the user input unit 430 may include various types of input means that may be operated by a user, such as a scroll key or a jog key, and the present embodiment does not limit the scope of the present disclosure.

The sensor unit 440 may include a gyro sensor 441 or an acceleration sensor 443. The gyro sensor 441 may sense information on the movement of the remote control device 200.

For example, the gyro sensor 441 may sense information on the operation of the remote control device 200 based on the x, y, and z axes. The acceleration sensor 443 may sense information on the movement speed of the remote control device 200 and the like. Meanwhile, a distance measurement sensor may be further provided, whereby a distance to the display unit 180 may be sensed.

The output unit 450 may output a video or audio signal corresponding to the operation of the user input unit 430 or a signal transmitted from the display device 100. The user may recognize whether the user input unit 430 is operated or whether the display device 100 is controlled through the output unit 450.

For example, the output unit 450 may include an LED module 451 that emits light, a vibration module 453 that generates vibration, a sound output module 455 that outputs sound, or a display module 457 that outputs a video when the user input unit 430 is operated or a signal is transmitted and received through the wireless communication unit 420.

The power supply unit 460 supplies power to the remote control device 200. The power supply unit 460 may reduce power consumption by stopping power supply when the remote control device 200 has not moved for a predetermined time. The power supply unit 460 may restart power supply when a predetermined key provided in the remote control device 200 is operated.

The storage unit 470 may store various types of programs and application data required for control or operation of the remote control device 200. When the remote control device 200 transmits and receives signals wirelessly through the display device 100 and the RF module 421, the remote control device 200 and the display device 100 transmit and receive signals through a predetermined frequency band. The control unit 480 of the remote control device 200 may store and refer to information on a frequency band capable of wirelessly transmitting and receiving signals to and from the display device 100 paired with the remote control device 200 in the storage unit 470.

The control unit 480 may control all matters related to the control of the remote control device 200. The control unit 480 may transmit a signal corresponding to a predetermined key operation of the user input unit 430 or a signal corresponding to the movement of the remote control device 200 sensed by the sensor unit 440 through the wireless communication unit 420.

The user input interface unit 150 of the display device 100 may include a wireless communication unit 411 capable of wirelessly transmitting and receiving signals to and from the remote control device 200, and a coordinate value calculating unit 415 capable of calculating coordinate values of a pointer corresponding to the operation of the remote control device 200.

The user input interface unit 150 may transmit and receive signals wirelessly to and from the remote control device 200 through the RF module 412. In addition, signals transmitted by the remote control device 200 according to the IR communication standard may be received through the IR module 413.

The coordinate value calculating unit 415 may correct a hand shake or an error based on a signal corresponding to the operation of the remote control device 200 received through the wireless communication unit 411, and calculate the coordinate values (x, y) of the pointer 205 to be displayed on the display unit 180.

The transmission signal of the remote control device 200 input to the display device 100 through the user input interface unit 150 may be transmitted to the control unit 170 of the display device 100. The control unit 170 may determine information on the operation and key operation of the remote control device 200 based on the signal transmitted by the remote control device 200, and control the display device 100 in response thereto.

As another example, the remote control device 200 may calculate pointer coordinate values corresponding to the operation and output the same to the user input interface unit 150 of the display device 100. In this case, the user input interface unit 150 of the display device 100 may transmit information on the received pointer coordinate values to the control unit 170 without a separate process of correcting a hand shake or error.

In addition, as another example, the coordinate value calculating unit 415 may be provided in the control unit 170 instead of the user input interface unit 150 unlike the drawing.

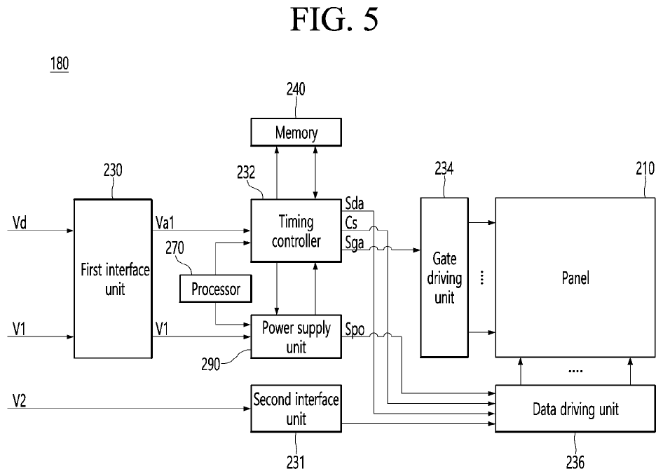

FIG. 5 is an internal block diagram of the display unit of FIG. 2.

Referring to the drawing, the display unit 180 based on an organic light emitting panel may include a panel 210, a first interface unit 230, a second interface unit 231, a timing controller 232, a gate driving unit 234, a data driving unit 236, a memory 240, a processor 270, a power supply unit 290, and the like.

The display unit 180 may receive a video signal Vd, first DC power V1, and second DC power V2, and display a predetermined video based on the video signal Vd.

Meanwhile, the first interface unit 230 in the display unit 180 may receive the video signal Vd and the first DC power V1 from the control unit 170.

Here, the first DC power supply V1 may be used for the operation of the power supply unit 290 and the timing controller 232 in the display unit 180.

Next, the second interface unit 231 may receive the second DC power V2 from the external power supply unit 190. Meanwhile, the second DC power V2 may be input to the data driving unit 236 in the display unit 180.

The timing controller 232 may output a data driving signal Sda and a gate driving signal Sga based on the video signal Vd.

For example, when the first interface unit 230 converts the input video signal Vd and outputs the converted video signal va1, the timing controller 232 may output the data driving signal Sda and the gate driving signal Sga based on the converted video signal va1.

The timing controller 232 may further receive a control signal, a vertical synchronization signal Vsync, and the like, in addition to the video signal Vd from the control unit 170.

In addition, the timing controller 232 may output the gate driving signal Sga for the operation of the gate driving unit 234 and the data driving signal Sda for operation of the data driving unit 236 based on a control signal, the vertical synchronization signal Vsync, and the like, in addition to the video signal Vd.

In this case, the data driving signal Sda may be a data driving signal for driving of RGBW subpixels when the panel 210 includes the RGBW subpixels.

Meanwhile, the timing controller 232 may further output the control signal Cs to the gate driving unit 234.

The gate driving unit 234 and the data driving unit 236 may supply a scan signal and the video signal to the panel 210 through a gate line GL and a data line DL, respectively, according to the gate driving signal Sga and the data driving signal Sda from the timing controller 232. Accordingly, the panel 210 may display a predetermined video.

Meanwhile, the panel 210 may include an organic light emitting layer and may be arranged such that a plurality of gate lines GL intersect a plurality of data lines DL in a matrix form in each pixel corresponding to the organic light emitting layer to display a video.

Meanwhile, the data driving unit 236 may output a data signal to the panel 210 based on the second DC power supply V2 from the second interface unit 231.

The power supply unit 290 may supply various levels of power to the gate driving unit 234, the data driving unit 236, the timing controller 232, and the like.

The processor 270 may perform various control of the display unit 180. For example, the gate driving unit 234, the data driving unit 236, the timing controller 232 or the like may be controlled.

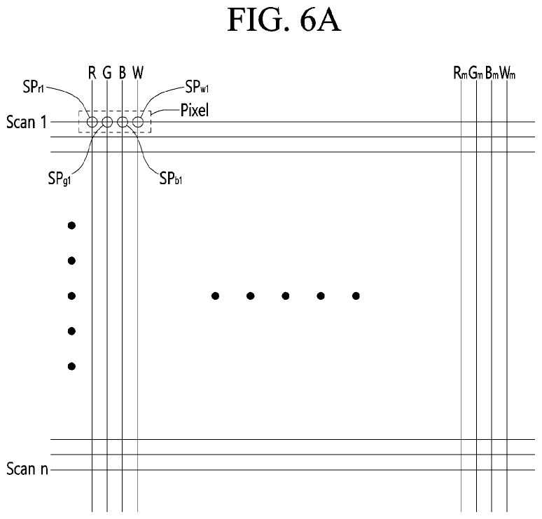

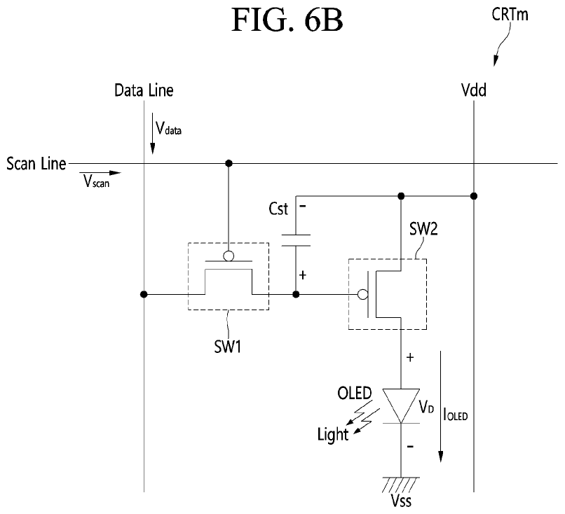

FIGS. 6A to 6B are views referred to for description of the organic light emitting panel of FIG. 5.

First, FIG. 6A is a diagram showing a pixel in the panel 210. The panel 210 may be an organic light emitting panel.

Referring to the drawing, the panel 210 may include a plurality of scan lines (Scan 1 to Scan n) and a plurality of data lines (R1, G1, B1, W1 to Rm, Gm, Bm and Wm) intersecting the scan lines.

Meanwhile, a pixel is defined at an intersection region of the scan lines and the data lines in the panel 210. In the drawing, a pixel having RGBW sub-pixels SPr1, SPg1, SPb1, and SPw1 is shown.

In FIG. 6A, although it is illustrated that the RGBW sub-pixels are provided in one pixel, RGB subpixels may be provided in one pixel. That is, it is not limited to the element arrangement method of a pixel.

FIG. 6B illustrates a circuit of a sub pixel in a pixel of the organic light emitting panel of FIG. 6A.

Referring to the drawing, an organic light emitting sub-pixel circuit CRTm may include a scan switching element SW1, a storage capacitor Cst, a driving switching element SW2, and an organic light emitting layer OLED, as active elements.

The scan switching element SW1 may be connected to a scan line at a gate terminal and may be turned on according to a scan signal Vscan, which is input. When the scan switching element SW1 is turned on, the input data signal Vdata may be transferred to the gate terminal of the driving switching element SW2 or one terminal of the storage capacitor Cst.

The storage capacitor Cst may be formed between the gate terminal and the source terminal of the driving switching element SW2, and store a predetermined difference between the level of a data signal transmitted to one terminal of the storage capacitor Cst and the level of the DC power Vdd transferred to the other terminal of the storage capacitor Cst.

For example, when the data signals have different levels according to a Pulse Amplitude Modulation (PAM) method, the level of power stored in the storage capacitor Cst may vary according to a difference in the level of the data signal Vdata.

As another example, when the data signals have different pulse widths according to the Pulse Width Modulation (PWM) method, the level of the power stored in the storage capacitor Cst may vary according to a difference in the pulse width of the data signal Vdata.

The driving switching element SW2 may be turned on according to the level of the power stored in the storage capacitor Cst. When the driving switching element SW2 is turned on, a driving current IDLED, which is proportional to the level of the stored power, flows through the organic light emitting layer OLED. Accordingly, the organic light emitting layer OLED may perform a light emitting operation.

The organic light emitting layer (OLED) includes a light emitting layer (EML) of RGBW corresponding to a subpixel, and may include at least one of a hole injection layer (HIL), a hole transport layer (HTL), an electron transport layer (ETL), and an electron injection layer (EIL) and may further include a hole blocking layer.

On the other hand, the sub pixels may emit white light in the organic light emitting layer (OLED) but, in the case of green, red, blue sub-pixels, a separate color filter is provided for realization of color. That is, in the case of green, red, and blue subpixels, green, red, and blue color filters are further provided, respectively. Meanwhile, since a white sub-pixel emits white light, a separate color filter is unnecessary.

On the other hand, although p-type MOSFETs are illustrated as the scan switching element SW1 and the driving switching element SW2 in the drawing, n-type MOSFETs or other switching elements such as JFETs, IGBTs, or SICs may be used.

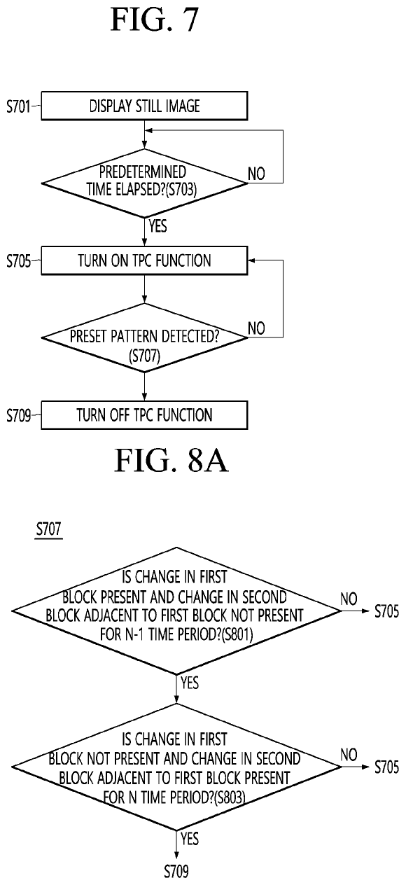

FIG. 7 is a flowchart illustrating a method of operating a display device according to an embodiment of the present disclosure.

Hereinafter, the luminance of a screen may have the same concept as the luminance of an image.

The controller 170 of the display device 100 displays a still image on the display unit 180 (S701).

In an embodiment, the still image may be based on an image signal received from an external device connected through the external device interface unit 135 of the display device 100. The still image may be an image displayed by an external device.

The external device may be a PC or a laptop, but this is only an example.

The still image may be an image received from a PC.

In another embodiment, the still image may be an image output by the display device rather than an image received from the external device.

The controller 170 determines whether a predetermined time has elapsed in a state of displaying the still image (S703).

In an embodiment, the predetermined time may be 2 minutes, but this is only an example.

The controller 170 may measure the APL of the still image and determine whether a change in the measured APL is less than a preset ratio. The preset ratio may be 0.4%, but this is only an example.

When the predetermined time has elapsed, the controller 170 turns on a temporal peak luminance control (TPC) function for lowering the luminance of a screen to default peak luminance (S705).

In an embodiment, the default peak luminance may be 75 nit, but this is only an example.

The controller 170 may control the display unit 180 to lower the luminance of the screen to the default peak luminance for activation of the TPC function.

Specifically, the controller 170 may control the current flowing through each of the plurality of pixels constituting the display unit 180 so that the luminance output from the panel 210 of the display unit 180 becomes the default peak luminance.

In another embodiment, the controller 170 may measure an average picture level (APL) of the still image and turn on the TPC function when a change in the APL measured for a predetermined time is less than a preset ratio. The preset ratio may be 0.4%, but this is only an example.

The controller 170 determines whether a preset pattern has been detected in a state in which the TPC function is activated (S707).

In an embodiment, the preset pattern may be a work pattern performed by the user on the screen of the PC connected to the display device 100.

In an embodiment, the preset pattern may be any one of a document work pattern and a mouse movement pattern.

The document work pattern may be a pattern in which text is being written through a document working window displayed on the display unit 180.

The mouse movement pattern may be a movement pattern of a mouse cursor displayed on the display unit 180.

When the mouse movement pattern or the document work pattern has been detected, the controller 170 may determine that the preset pattern for releasing the TPC function is detected.

When the mouse movement pattern or the document work pattern has been detected in a state in which the still image is being displayed, the controller 170 may determine that the preset pattern for releasing (or turning off) the TPC function has been detected.

The controller 170 turns off the TPC function when the preset pattern has been detected (S709).

The controller 170 may turn off the TPC function when the mouse movement pattern or the document work pattern has been detected in a state in which the still image is being displayed.

The controller 170 may control the display unit 180 to output the original peak luminance of the still image, after the TPC function is turned off.

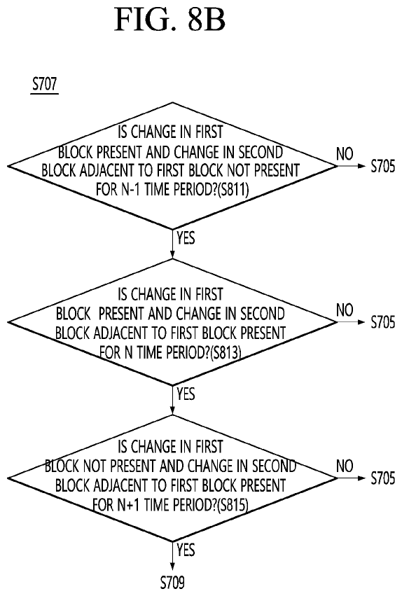

FIGS. 8A to 10 are views illustrating a process of detecting a document work pattern according to an embodiment of the present disclosure.

FIGS. 8A and 8B are flowcharts illustrating a process of detecting that the preset pattern is a document work pattern in step S707 of FIG. 7.

The screen of the display unit 180 may be divided into a preset number of blocks. One block may correspond to a part of one image frame. A part of the image frame may be referred to as a block image frame.

The preset number may be 10 or 30.

Hereinafter, it is assumed that the screen is divided into 10 blocks.

In addition, an N−1 time period, an N time period, and an N+1 time period are unit time periods, and may represent a time period taken until 30 image frames are output. The unit time period may be 1 second, but this is only an example.

Referring to FIG. 8A, the controller 170 of the display device 100 determines whether a change in a first block is present and a change in a second block adjacent to the first block is not present, during the N−1 time period (S801).

In an embodiment, the controller 170 may determine that a block change is present, when the block image frame corresponding to the block is changed more than once while 30 image frames output for a unit time are output.

When a first block image frame and a second block image frame following the first block image frame are different from each other, the controller 170 may determine that the block image frame has been changed.

In an embodiment, when the block image frame corresponding to the block is not changed while 30 image frames output for a unit time are output, the controller 170 may determine that the block change is not present.

When the change in the first block is present and the change in the second block adjacent to the first block is not present during the N−1 time period, the controller 170 may determine whether the change in the first block is not present and the change in the second block adjacent to the first block is present during the N time period (S803).

On the other hand, in the case other than the case where the change in the first block is present and the change in the second block adjacent to the first block is present during the N−1 time period, the ON state of the TPC function may be maintained according to step S705.

The controller 170 turns off the TPC function, upon determining that the change in the first block is not present and that the change in the second block adjacent to the first block is present during the N time period (S709).

Next, FIG. 8B will be described.

Referring to FIG. 8B, the controller 170 of the display device 100 determines whether the change in the first block is present and the change in the second block adjacent to the first block is not present during the N−1 time period (S811).

In an embodiment, the controller 170 may determine that the change in the block is present, when the block image frame corresponding to the block is changed more than once while 30 image frames output for a unit time are output.

In an embodiment, when the block image frame corresponding to the block is not changed while 30 image frames output for a unit time are output, the controller 170 may determine that the change in the block is not present.

When the change in the first block is present and the change in the second block adjacent to the first block is not present during the N−1 time period, the controller 170 determines whether the change in the first block and the second block is present during the N time period (S813).

This is to consider a situation in which characters typed in a typing process are displayed to overlap the first block and the second block.

Upon determining that the change in the first block and the second block is present during the N time period, the controller 170 determines that the change in the first block is not present and the change in the second block adjacent to the first block is present during the N+1 time period (S815).

Upon determining that the change in the first block is not present and the change in the second block adjacent to the first block is present during the N+1 time period, the controller 170 turns off the TPC function (S709).

Hereinafter, the process of detecting the document work pattern will be described in detail.

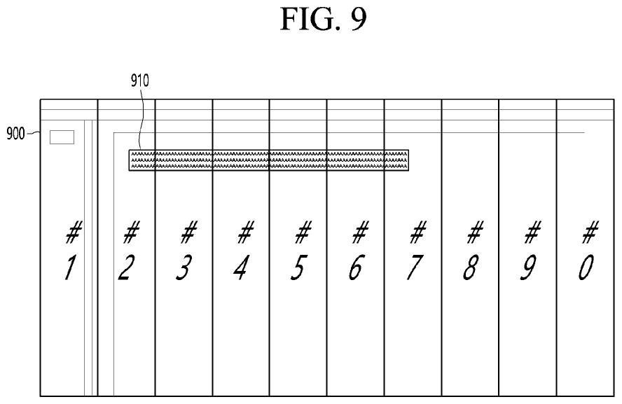

Referring to FIG. 9, a document work window 900 displayed on the display unit 180 of the display device 100 is shown.

The document work window 900 may be a window based on an image signal received from an external device connected to the display device 100.

The document work window 900 may be divided into a plurality of blocks #1 to #10.

Each block may have a rectangular shape in which a vertical length is longer than a horizontal length.

The document work window 900 may be one still image.

The user may input text from left to right through typing in the document work window 900, and the input text 910 may be displayed in the document work window 900.

The text 910 consists of three lines. In addition, only the second to seventh blocks #2 to #7 are typed.

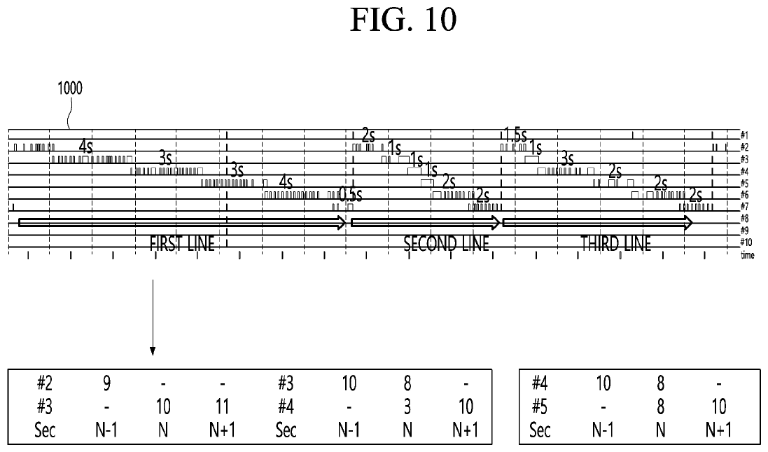

Referring to FIG. 10, a graph 1000 showing a change in each block over time is shown.

A horizontal axis of the graph 1000 may be a time axis, and one interval on the time axis may be a unit time period. A vertical axis of the graph 1000 may indicate whether or not characters are typed. Whether to type may have a value of 1 or 0, but this is only an example.

The controller 170 may determine that the block has been changed when typing occurs, that is, when a character is input according to user's typing.

During the N−1 time period, typing has occurred nine times in the second block #2 and typing has occurred 0 times in the third block #3. The third block #3 may be a block adjacent to the right side of the second block #2.

That is, the controller 170 may determine that 9 changes have occurred in the second block #2 and 0 changes have occurred in the third block #3 during the N−1 time period.

During the N time period, typing has occurred 0 times in the second block #2 and typing has occurred 10 times in the third block #3.

That is, the controller 170 may determine that 0 changes have occurred in the second block #2 and 10 changes have occurred in the third block #3 during the N time period.

When the change is present in the second block #2 and the change is not present in the third block #3 adjacent to the second block #2 during the N−1 time period, and the change is not present in the second block #2 and the change is present in the third block #3 during the N time period, the controller 170 may determine that the document work pattern has been detected (which may correspond to the embodiment of FIG. 8A).

When the document work pattern is detected, the controller 170 may control the display unit 180 to turn off the TPC function to output the original luminance of the document work window 1000.

Accordingly, since the document work window 900 is not recognized as a still image, the TPC function is turned off and the screen may be prevented from darkening during document work.

Next, it will be described with reference to a third block #3 and a fourth block #4.

The fourth block #4 may be a block adjacent to the right of the third block #3.

During the N−1 time period, typing has occurred 10 times in the third block #3 and typing has occurred 0 times in the fourth block #4.

That is, the controller 170 may determine that 10 changes have occurred in the third block #3 and 0 changes have occurred in the fourth block #4 during the N−1 time period.

During the N time period, typing has occurred 8 times in the third block #3 and typing has occurred three times in the fourth block #4.

That is, the controller 170 may determine that 8 changes have occurred in the third block #3 and 3 changes have occurred in the fourth block #4 during the N time period.

During the N+1 time period, typing has occurred 0 times in the third block #3 and typing has occurred 10 times in the fourth block #4.

That is, the controller 170 may determine that no change has occurred in the third block #3 and 10 changes have occurred in the fourth block #4 during the N+1 time period.

Upon determining that there is a change in the third block #3 and there is no change in the block #4 during the N−1 time period, there is a change in the third block #3 and the fourth block #4 during the N time period, and there is no change in the third block #3 and there is a change in the fourth block #4 during the N+1 time period, the controller 170 may determine that the document work pattern has been detected (which may correspond to the embodiment of FIG. 8B).

When the document work pattern is detected, the controller 170 may control the display unit 180 to turn off the TPC function such that the original luminance of the document work window 1000 is output.

When the document work pattern is detected in a state in which the TPC function is turned on, the controller 170 may control the display unit 180 to change the TPC function from on to off such that the original luminance is output.

Accordingly, since the document work window 900 is not recognized as a still image, the TPC function is turned off and the screen may be prevented from darkening during document work.

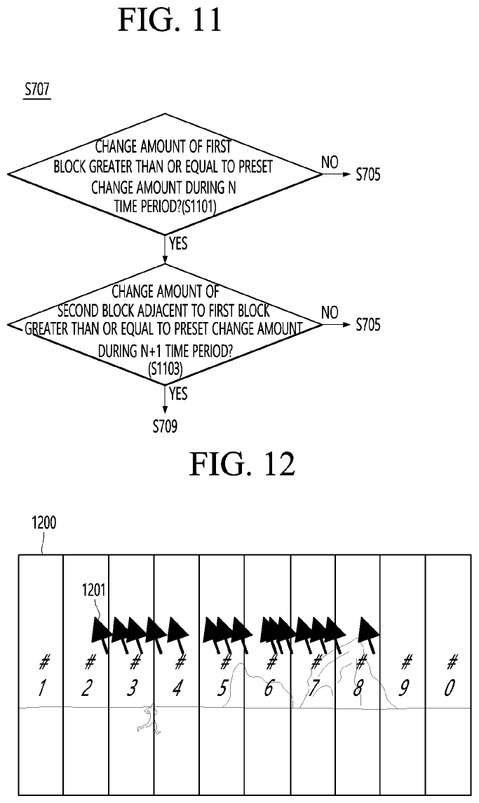

FIGS. 11 to 14 are views illustrating a process of detecting a mouse movement pattern according to an embodiment of the present disclosure.

FIG. 11 is a flowchart illustrating a process of detecting that the preset pattern is a mouse movement pattern in step S707 of FIG. 7.

Referring to FIG. 11, the controller 170 determines whether the change amount of the first block of the plurality of blocks constituting the screen is greater than or equal to a preset change amount during the N time period (S1101).

The N time period is a unit time period, and may be 1 second, but this is only an example.

In an embodiment, the controller 170 may determine more than a preset change amount has occurred, when the number of changes of the block image frame corresponding to the first block is greater than or equal to a preset number during the N time period.

That is, the change amount of the block may indicate the number of times of changing the block image frame corresponding to the block during a unit time. The controller 170 may count the number of times of changing the block image frame corresponding to the block in a process of outputting 30 image frames for a unit time, and obtain the result of counting as the change amount of the block.

When the change amount of the first block is greater than or equal to the preset change amount during the N time period, the controller 170 determines whether the change amount of the second block adjacent to the first block is greater than or equal to the preset change amount during the N+1 time period (S1103).

That is, the controller 170 may determine whether the change amount of the second block adjacent to the first block is greater than or equal to the preset change amount during the N+1 time period following the N time period.

When the change amount of the second block adjacent to the first block is greater than or equal to the preset change amount during the N+1 time period, the controller 170 determines that the mouse movement pattern has been detected and turns off the TPC function (S709).

More specifically, when the change amount of the first block is not detected during the N+1 time period and the change amount of the second block is greater than or equal to the preset change amount, the controller 170 may determine that the mouse movement pattern has been detected.

Referring to FIG. 12, a still image 1200 displayed on the display unit 180 of the display device 100 is shown.

The still image 1200 may be a wallpaper image of a PC connected to the display device 100.

A mouse cursor 1201 moves on the still image 1200 according to movement of the mouse.

A screen constituting the still image 1200 may be divided into a total of 10 blocks #0 to #9.

The controller 170 may determine that the mouse movement pattern has been detected, when the change amount of a specific block is greater than or equal to the preset change amount during a unit time period and the change amount of the block directly adjacent to the specific block is greater than or equal to the preset change amount during a next unit time period.

Upon determining that the mouse movement pattern has been detected, the controller 170 may turn off the TPC function. Even if the still image 1200 is displayed, when mouse movement is detected, since the user is performing some operation on the PC, the brightness of the screen is not prevented from being lowered.

Meanwhile, in another embodiment of the present disclosure, the still image of FIG. 12 may be an image displayed by the display device 100, not an image received from the PC.

In this case, the display device 100 may display a cursor that moves according to the movement of the remote control device 200. The display device 100 may determine that a cursor movement pattern is detected when the change amount of a specific block is greater than or equal to the preset change amount during the unit time period and the change amount of the block directly adjacent to a specific block is greater than or equal to the preset change amount during the next unit time period.

The display device 100 may turn off the TPC function, when the cursor movement pattern has been detected.

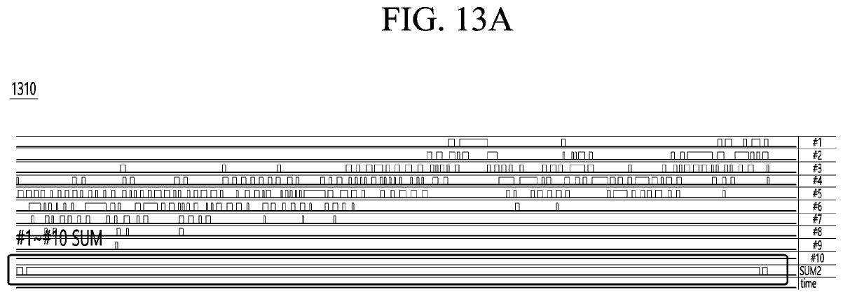

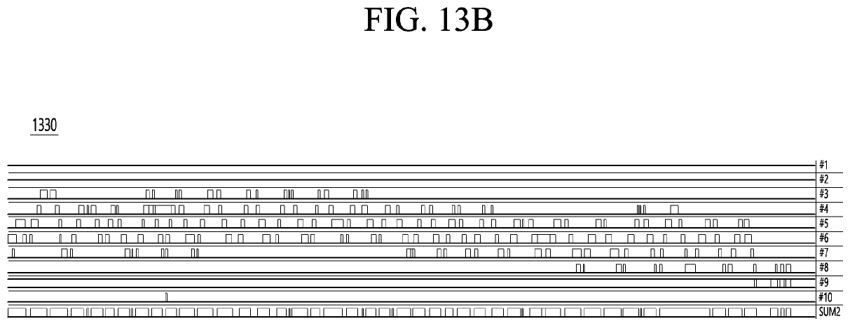

FIGS. 13A and 13B are graphs illustrating a change amount occurring in each block over time.

A horizontal axis of each graph may be a time axis, and one interval on the time axis may be a unit time period. A vertical axis of each graph may indicate whether a change has occurred in each block. Whether a change has occurred may be expressed as 1 or 0.

A first graph 1310 of FIG. 13A illustrates a case in which the mouse movement of the PC connected to the display device 100 is a fast speed, and a second graph 1330 of FIG. 13B illustrates a case in which the mouse movement of the PC connected to the display device 100 is a normal speed.

When the number of frame changes of a specific block is greater than or equal to a preset number during a unit time period and the number of frame changes of an adjacent block adjacent to the specific block is greater than or equal to the preset number during a next unit time period, the controller 170 may determine that the mouse movement pattern has been detected.

More specifically, when the number of frame changes of the specific block is greater than or equal to the preset number of times during the unit time period, the frame change of the specific block is not present during the next unit time period, and the number of frame changes of the adjacent block is greater than or equal to the preset number, the controller 170 may determine that the mouse movement pattern has been detected.

This is because, as the mouse cursor is moved, the frame change of the specific block may not occur in the next unit time period.

As such, according to an embodiment of the present disclosure, the display device 100 may turn off the TPC function as the mouse movement pattern is detected, thereby preventing interference with the user's PC work.

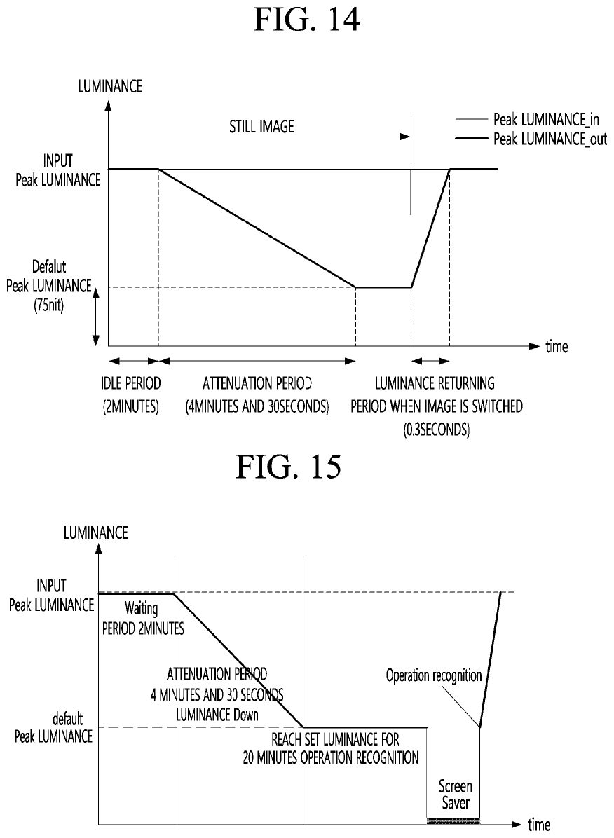

FIG. 14 is a view illustrating a process of turning off the TPC function as a preset pattern is detected after the TPC function is turned on, according to an embodiment of the present disclosure.

The controller 170 may determine whether a still image is input during an IDLE period (waiting period).

The controller 170 may turn on the TPC function when the APL change amount of the still image is less than 0.4% during an IDLE period. As the TPC function is turned on, the input peak luminance of the still image may gradually decrease to default peak luminance. The luminance of the still image may fall from the input peak luminance during an attenuation period (e.g., 4 minutes and 30 seconds) to reach the default peak luminance. Thereafter, when a preset pattern is detected or the image is switched while the luminance of the still image is maintained at the default peak luminance, the TPC function may be turned off. As the image is switched, the luminance may reach the input peak luminance during 0.3 seconds.

FIG. 15 is a view illustrating a process of executing a screen saver function when the default peak luminance is maintained for a preset time after the TPC function is turned on, according to an embodiment of the present disclosure.

As the TPC function is turned on, the luminance of the still image may reach the default peak luminance. When the luminance of the still image reaches the default peak luminance for 20 minutes, the controller 170 may execute a screen saver function. The screen saver function may be a function for turning off the screen of the display unit 180 or providing at least power to the display unit 180 to protect the screen.

The controller 170 may turn on the screen and turn off the TPC function when a preset pattern is detected after executing the screen saver function.

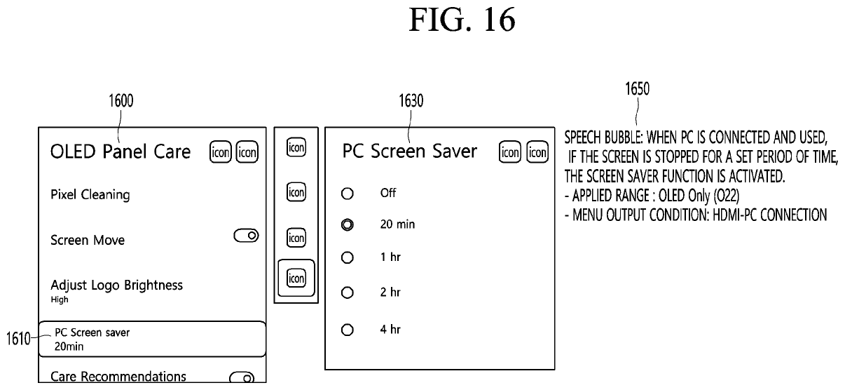

FIG. 16 is a view illustrating a process of setting a screen saver function of a PC connected to a display device according to an embodiment of the present disclosure.

The display device 100 may display a panel care menu 1600 for the care of an OLED display on the display unit 180.

The panel care menu 1600 may include a PC screen saver item 1610.

The PC screen saver item 1610 may be an item guiding the operation of the screen saver function, when a PC is connected to the display device 100 and the screen is stopped for a set time.

When the PC screen saver item 1610 is selected, the controller 170 may display a time setting menu 1630 for setting the operation time of the PC screen saver function.

The controller 170 may further display a speech bubble 1650 explaining the function of the PC screen saver in addition to the time setting menu 1630.

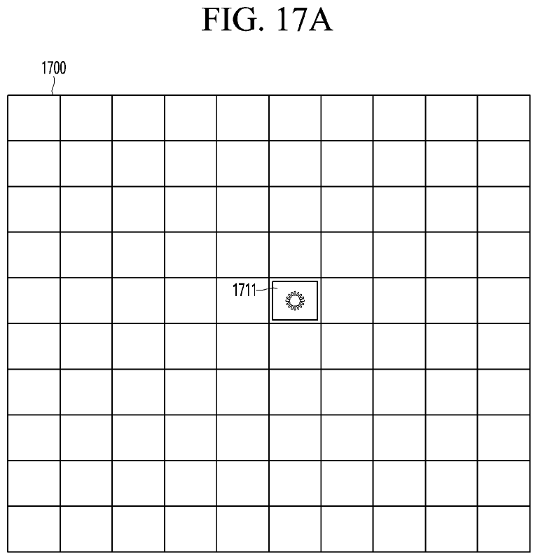

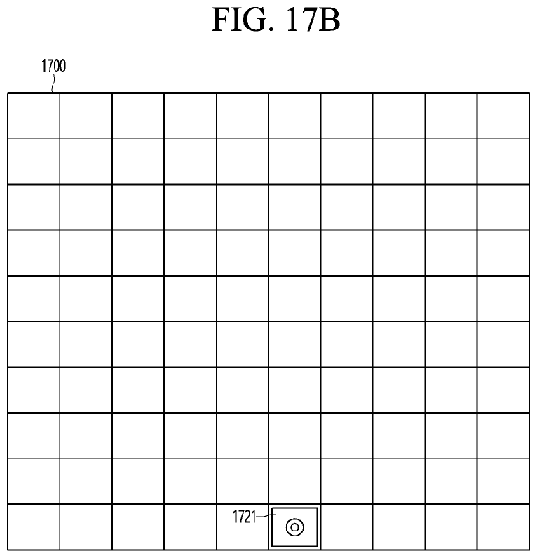

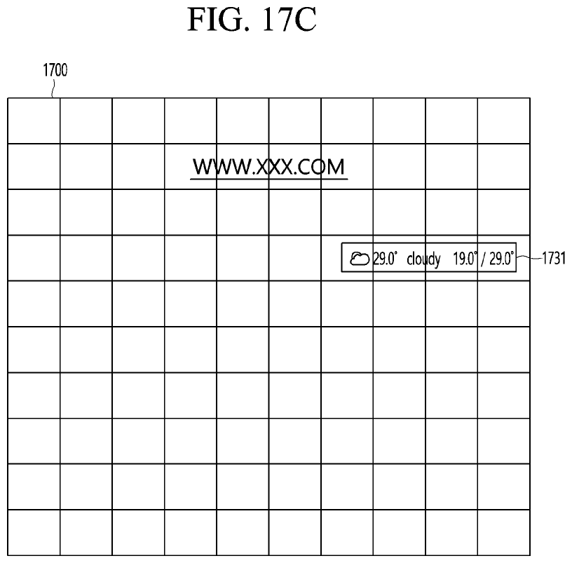

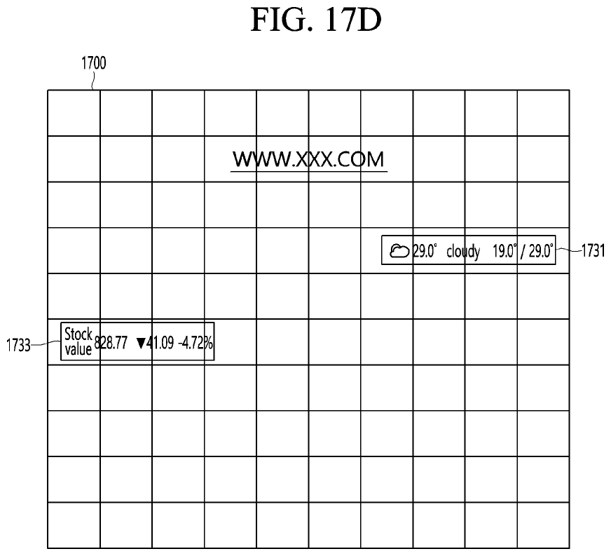

FIGS. 17A to 17D are diagrams illustrating an exceptional situation in which the TPC function is not turned off even when a block change occurs while the TPC function is turned on according to an embodiment of the present disclosure.

In FIGS. 17A to 17D, it is assumed that the screen 1700 of the display unit 180 is divided into a total of 30 blocks having a square shape.

First, FIG. 17a will be described.

A loading image 1711 may be displayed on the screen 1700. The loading image 1711 is an image displayed while waiting until a program updates or a program window or a web page window is opened. The loading image 1711 may change in real time to indicate that it is waiting.

The controller 170 may determine that the preset pattern has not been detected, when a change occurs in any one (block on which the loading image is displayed) of a plurality of blocks during a unit time period or a plurality of unit time periods in a state in which the TPC function is turned on.

That is, the controller 170 may not turn off the TPC function, as a change is occurring in some blocks but a situation in which user work is not performed is detected.

Next, FIG. 17B will be described.

A record button 1721 indicating that an image is being recorded may be displayed on the screen 1700. The record button 1721 may blink while the image is being recorded.

When a change occurs in any one (block on which the record button is displayed) of a plurality of blocks during a unit time period or a plurality of unit time periods in a state in which the TPC function is turned on, the controller 170 may determine that the preset pattern has not been detected.

Next, FIG. 17C will be described.

A website image is displayed on the screen 1700, and the website image may include a weather banner 1731. The weather banner 1731 includes text indicating temperature or weather, and may be changed at regular time intervals.

The controller 170 may not turn off the TPC function when three blocks on which the weather banner 1731 is displayed are periodically changed. That is, when three blocks on which the weather banner 1731 is displayed are periodically changed, the controller 170 may determine that the preset pattern has not been detected.

Next, FIG. 17D will be described.

The screen 1700 displays a website image, and the website image may include a weather banner 1731 and a stock banner 1733.

The stock banner 1733 may include text representing stock information.

Similarly to the weather banner 1731, the stock banner 1733 may also be changed at regular time intervals.

When the three blocks on which the weather banner 1731 is displayed and the three blocks on which the stock banner 1733 is displayed are periodically changed, the controller 170 may determine that the preset pattern has not been detected.

As such, according to an embodiment of the present disclosure, it is possible to prevent the TPC function from being turned off unnecessarily by detecting a situation in which the user does not work.

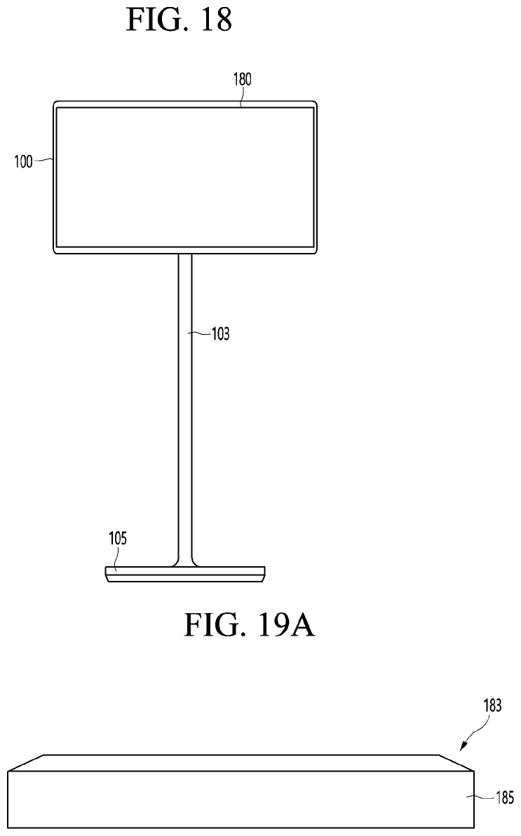

FIG. 18 is a diagram illustrating a configuration of a stand-type display device according to an embodiment of the present disclosure.

The embodiment of the present disclosure is applicable to the stand-type display device 100.

A shaft 103 and a stand base 105 may be connected to the display device 100.

The shaft 103 may connect the display device 100 and the stand base 105. The shaft 103 may extend vertically.

A lower end of the shaft 103 may be connected to an edge of the stand base 105.

The lower end of the shaft may be rotatably connected to the circumference of the stand base 105.

The display device 100 and the shaft 103 may rotate about a vertical axis with respect to the stand base 105.

An upper portion of the shaft 103 may be connected to a rear surface of the display device 100.

The stand base 105 may serve to support the display device 100.

The display device 100 may be configured to include the shaft 103 and the stand base 105.

The display device 100 may rotate around a point where the upper portion of the shaft 103 and the rear surface of the display 180 contact each other.

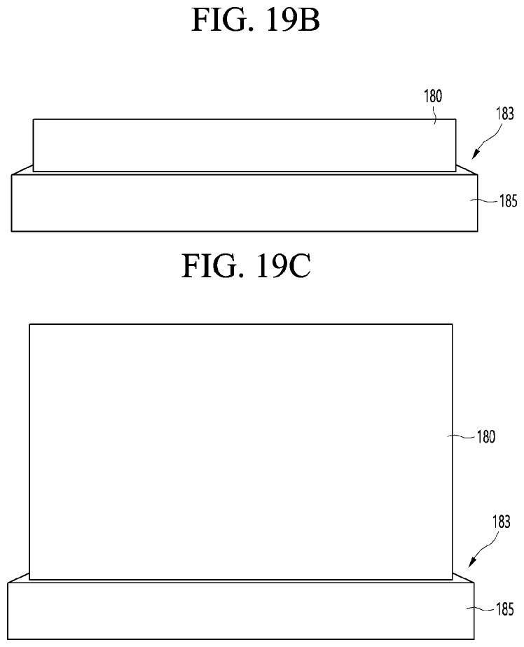

FIGS. 19A to 19C are diagrams illustrating a configuration of a flexible display device according to an embodiment of the present disclosure.

The embodiment of the present disclosure is applicable to a flexible display device.

FIG. 19A is an exemplary view illustrating a state of the display unit when a display mode is a zero-view mode according to an embodiment of the present disclosure, FIG. 19B is an exemplary view illustrating a state of the display unit when the display mode is a partial view mode according to an embodiment of the present disclosure, and FIG. 19C is an exemplary view illustrating a state of the display unit when the display mode is a full view mode according to an embodiment of the present disclosure.

The zero view mode may be a mode in which the display unit 180 operates while the entire display unit is drawn into the housing 183. As shown in FIG. 19A, in the zero view mode, the entire display unit 180 may be located inside the housing 183.

For example, when the display device 100 operates in a speaker mode, the display mode may be controlled to the zero view mode. Also, when the display device 100 is powered off, the display unit 180 may be controlled in the zero view mode.

When the display unit 180 is in the zero view mode, content may not be displayed in the entire area of the display unit 180. The display unit 180 may be turned off in the zero view mode.

The partial view mode may be a mode in which the display unit 180 operates while a part thereof being drawn out from the housing 183. As shown in FIG. 19B, in the partial view mode, a part of the display unit 180 may be located inside the housing 183, and the remaining part of the display unit 180 may be located outside the housing 183.

For example, the display device 100 may control the display mode to the partial view mode, when operating in a menu mode, a mood mode, a music mode, a frame mode or a watch mode.

The display unit 180 may display content only in an area drawn out from the housing 183 of the display unit 180, in the partial view mode. That is, in the partial view mode, content may not be displayed in an area drawn into the housing 183 of the display unit 180.

The full view mode may be a mode in which the display unit 180 operates in a state in which the display unit is maximally drawn out from the housing 183. That is, the full view mode may be a mode in which the drawn-out length of the display unit 180 drawn out from the housing 183 is the maximum. As shown in FIG. 19C, in the full view mode, the entire display unit 180 may be drawn out from the housing 183.

For example, when the display device 100 operates in the normal mode, the display mode may be controlled to the full view mode, and, in this case, the normal mode is a mode in which a broadcast image, an input image from the external device interface unit 135, etc. are output.

The display unit 180 may display content in the region drawn out from the housing 183 of the display unit 180, in the full view mode. In the full view mode, the display unit 180 may display content in the entire area, in which the image is able to be output, of the display unit 180.

As described with reference to FIGS. 19A to 19C, the display area of the content may vary according to the display mode, that is, the drawn-out length of the display unit 180.

According to an embodiment of the present disclosure, the above-described method may be implemented with codes readable by a processor on a medium in which a program is recorded. Examples of the medium readable by the processor include a ROM (Read Only Memory), a Random Access Memory (RAM), a CD-ROM, a magnetic tape, a floppy disk, an optical data storage device, and the like.

The display device described above is not limited to the configuration and method of the above-described embodiments, and the above embodiments may be configured by selectively combining all or some of embodiments such that various modifications may be made.

1. A display device comprising:
a display unit configured to display a still image on a screen with an input peak luminance,
wherein the screen is divided into a plurality of blocks including at least a first block and a second block directly adjacent to the first block; and
a controller configured to:
obtain an input peak luminance of the still image;
turn on a luminance control function for lowering the luminance of the screen from the input peak luminance to a default peak luminance if there is no change in the still image for a predetermined time period; and
turn off the luminance control function if a preset work pattern is detected in a state in which the luminance control function is turned on,
wherein the controller is further configured to:
determine, for a first unit time period, whether a change in the first block and a change in the second block is present,
determine, for a second unit time period following the first unit time period, whether a change in the first block and a change in the second block is present, and
detect the preset work pattern performed by a user on the screen if:
a change in the first block and no change in the second block is determined for the first unit time period, and
no change in the first block and a change in the second block is determined for the second unit time period.

2-5. (canceled)

6. The display device of claim 1, further comprising an external device interface unit configured to receive an image signal from an external device,
wherein the still image is based on the image signal received from the external device.

7. (canceled)

8. The display device of claim 1, wherein the controller is configured to perform a screen saver function when a preset time has elapsed in the state in which the luminance control function is turned on.

9. The display device of claim 1, wherein the controller is configured to turn off the luminance control function when the still image is switched to a new image.

10. The display device of claim 1, wherein the display unit comprises a plurality of pixels each including an organic light-emitting layer.

11. A method of operating a display device, the method comprising:
displaying a still image on a screen of a display unit with an input peak luminance,
wherein the screen is divided into a plurality of blocks including at least a first block and a second block directly adjacent to the first block;
turning on a luminance control function for lowering a luminance of the screen from the input peak luminance to a default peak luminance if there is no change in the still image for a predetermined time period; and
turning off the luminance control function if a preset work pattern is detected in a state in which the luminance control function is turned on,
wherein the method further comprises:
determining, for a first unit time period, whether a change in the first block and a change in the second block is present;
determining, for a second unit time period following the first unit time period, whether a change in the first block and a change in the second block is present; and
detecting the preset work pattern performed by a user on the screen if:
a change in the first block and no change in the second block is determined for the first unit time period, and
no change in the first block and a change in the second block is determined for the second unit time period.

12-15. (canceled)

16. The method of claim 11, further comprising receiving an image signal from an external device,
wherein the still image is based on the image signal received from the external device.

17. (canceled)

18. The method of claim 11, further comprising performing a screen saver function when a preset time has elapsed in the state in which the luminance control function is turned on.

19. The method of claim 11, wherein further comprising turning off the luminance control function when the still image is switched to a new image.

20. The method of claim 11, wherein the display unit comprises a plurality of pixels each including an organic light-emitting layer.
